(19) United States
(12) Patent Application Publication
(10) Pub. No.: US 2002/0069539 A1
(43) Pub. Date: Jun. 13, 2002

(54) Blade tensioner

(75) Inventor: Naosumi Tada, Nabari City (JP)

Correspondence Address: BORGWARNER INC., Patent Department, 3001 West Big Beaver Road, Suite 200, P.O. Box 5060, Troy, MI, 48007-5060, US

(73) Assignee: Borg-Warner Automotive K.K.

(21) Appl. No.: 09/879,580

(22) Filed: Jun. 12, 2001

(30) Foreign Application Priority Data
Jun. 12, 2000 (JP) 2000-176514

(51) Int. Cl. B23D 57/02

(52) U.S. Cl. 30/383

(57) ABSTRACT

A blade tensioner is configured with a base, a blade shoe having a chain sliding face provided on base, and several plate-spring-like blade springs stacked on the reverse side of the chain sliding face of the blade shoe in order to apply a spring force to blade shoe. A base part of blade shoe is provided in such a manner that it can pivot freely on the base, and a friction material is provided at the part where a tip part of the blade shoe contacts a sliding face of the base. In addition, respective edge parts of the blade springs are inserted into respective slots on the blade shoe.

### FIELD OF THE INVENTION

The present invention pertains to a blade tensioner, and particularly to a blade tensioner provided with a blade shoe having a chain sliding face and several plate-like blade springs for applying spring force to the blade shoe.

### BACKGROUND OF THE INVENTION

A blade tensioner is often utilized as a tensioner for applying tension to a chain. A conventional tensioner may be generally configured with a blade shoe provided with a chain sliding face, a base which allows a base part of the blade shoe to pivot freely and a tip part of the blade shoe to slide freely, and several plate-spring-like blade springs stacked on the reverse side of the chain sliding face of the blade shoe in order to apply a spring force to the blade shoe. Respective edge parts of the blade springs can be inserted into slots created at the tip part and the base part of the blade shoe.

During the operation of the chain, the chain may run while sliding on the chain sliding face of the blade shoe. At this time, a pressing load can be created as the blade shoe and the blade springs are deformed and acts upon the chain, so that constant tension of the chain is maintained. In addition, chord vibrations caused by thrashing of the chain and/or fluctuation of tension can be propagated to the respective blade springs in the blade shoe via the blade shoe. At this time, when the respective blade springs are subjected repeatedly to elastic deformation and return deformation, a damping force can be created as adjoining blade springs slide against each other, and the chord vibrations of the chain are damped.

In recent applications of a blade tensioner, a large demand has emerged for the appearance of a blade tensioner capable of applying an even greater damping force to the chain. However, in the case of the aforementioned conventional blade tensioner, the damping force is typically created only by means of sliding resistance between the stacked blade springs. Thus, the aforementioned conventional structure has limitations in terms of improvement of damping force.

### SUMMARY OF THE INVENTION

In an aspect of the invention, the tensioner may be provided with a base and an arcuately-shaped blade shoe having a sliding face against which the chain slides as well as a base part and a tip part. The base part of the blade shoe may be supported by the base in such a manner that the base part can pivot freely and the tip part may be provided in such a manner that it can slide freely on a sliding face created on the base. A friction material can be provided at the contact part between the tip part and the sliding face. For example, the friction part may be inserted into the tip part of the blade shoe. Several plate-spring-like blade springs can be provided on the reverse side of the chain sliding face of the blade shoe, wherein their respective edge parts are inserted into slots created respectively at the base part and the tip part of the blade shoe in order to apply a spring force to the blade shoe.

According to an aspect of the invention, when chord vibrations caused by thrashing of the chain and/or fluctuation of tension act upon the blade shoe, not only can a damping force be created as adjoining blade springs slide against each other while the respective blade springs in the blade shoe are subjected repeatedly to elastic deformation and return deformation, but great sliding resistance can also be created as the friction material at the tip part of the blade shoe slides on the sliding face of the base, so that the damping force of the blade tensioner can be further improved by the sliding resistance.

In another aspect of the invention, the tensioner may be provided with a chain sliding face against which a chain slides, an arcuately shaped blade shoe, a base having a sliding face which allows a base part of the blade shoe to pivot freely and a tip part of the blade shoe to slide freely and a friction material provided on the sliding face, and several plate-spring-like blade springs provided on the reverse side of the chain sliding face of the blade shoe, wherein their respective edge parts can be inserted into slots created respectively at the base part and the tip part of the blade shoe in order to apply a spring force to the blade shoe.

According to an aspect of the invention, when chord vibrations caused by thrashing of the chain and/or fluctuation of tension act upon the blade shoe, not only can a damping force be created as adjoining blade springs slide against each other while the respective blade springs in the blade shoe are subjected repeatedly to elastic deformation and return deformation, but great sliding resistance also may be created as the tip part of the blade shoe slides against the friction material on the sliding face of the base, so that the damping force of the blade tensioner can be further improved by the sliding resistance.

In yet another aspect of the invention, the blade tensioner may be provided with a chain sliding face against which the chain slides, an arcuately shaped blade shoe, a base having a sliding face which allows the base part of the blade shoe to pivot freely and the tip part of the blade shoe to slide freely, and several plate-spring-like blade springs provided on the reverse side of the chain sliding face of the blade shoe, wherein their respective edge parts are inserted into slots created respectively at the base part and the tip part of the blade shoe in order to apply a spring force to the blade shoe. In addition, a friction material can be provided at the base parts of the respective slots of the blade shoe where they contact the blade springs.

According to an aspect of the invention, when chord vibrations caused by thrashing of the chain and/or fluctuation of tension act upon the blade shoe, not only may a damping force be created as adjoining blade springs slide against each other while the respective blade springs in the blade shoe are subjected repeatedly to elastic deformation and return deformation, but great sliding resistance can also be created as the blade spring or system slides against the friction materials provided at the bottom of the respective slots of the blade shoe, so that the damping force of the blade tensioner can be further improved by the sliding resistance. The friction materials may also be inserted into the base parts of the respective slots of the blade shoe.

According to another aspect of the invention, the blade tensioner may be provided with an arcuately shaped blade shoe having a sliding face against which a chain slides, a base wherein a base part of the blade shoe is provided in such a manner that it can pivot freely, and a plastic sliding block is provided which allows the tip part of the blade shoe to slide freely. Several plate-spring-like blade springs may be provided on the reverse side of the chain sliding face of the blade shoe, wherein their respective edge parts are inserted into slots created respectively at the base part and the tip part of the blade shoe in order to apply a spring force to the blade shoe.

According to an aspect of the invention, when chord vibrations caused by thrashing of the chain and/or fluctuation of tension act upon the blade shoe, not only may a damping force be created as adjoining blade springs slide against each other while the respective blade springs in the blade shoe are subjected repeatedly to elastic deformation and return deformation, but great sliding resistance can also be created as the tip part of the blade shoe slides on the plastic sliding block, so that the damping force of the blade tensioner is further improved by the sliding resistance.

In any of the aspects of the invention, the friction material may be provided by means of bonding, welding, or insert-molding, and it is desirable that it be configured using rubber, plastic, or friction paper.

### BRIEF DESCRIPTION OF THE DRAWINGS

FIG. 1 is a side view of a blade tensioner in accordance with an aspect of the present invention;

FIG. 2 is a side view of a blade tensioner in accordance with another aspect of the present invention;

FIG. 3 is a side view of a blade tensioner in accordance with yet another aspect of the present invention; and

FIG. 4 is a side view of a blade tensioner in accordance with another aspect of the present invention.

### DETAILED DESCRIPTION

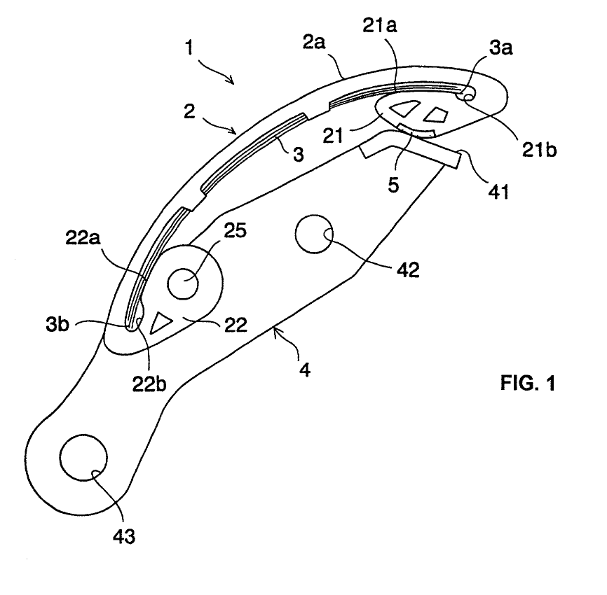

FIG. 1 shows a blade tensioner in accordance with an aspect of the present invention. As shown in FIG. 1, the blade tensioner 1 is configured with a blade shoe 2 having an arcuately shaped chain sliding face 2a, several blade springs 3 stacked on the reverse side of the chain sliding face 2a of the blade shoe 2 in order to apply a spring force to the blade shoe 2, and a base 4 for supporting the blade shoe 2.

Slots 21a and 22a are created at a tip part 21 and a base part 22 of the blade shoe 2, and respective edge parts 3a and 3b of the blade springs 3 are inserted into slots 21a and 22a. In addition, concave parts 21b and 22b are created in the respective slots 21a and 22a in order to avoid interference with the edge parts 3a and 3b of the blade springs 3.

Bolt holes 42 and 43 are created in the base 4 in order to insert the attachment bolts used to install the blade tensioner 1 into an engine. A sliding face 41 against which the tip part 21 of the blade shoe 2 can slide while remaining in contact with it is created at the tip of the base 4, and a pin 25 supporting the base part 22 of the blade shoe 2 while allowing it to pivot freely is fixed by one end near the center of the base 4.

Friction material 5 is provided at the tip part 21 of blade shoe 2 where it contacts with the sliding face 41 of the base 4. The friction material 5 is attached to the tip part 21 by means of bonding, welding including burn-in, or coating, or it may be buried into the tip part 21 by means of an insert-molding method simultaneously with the formation of the resin for the blade shoe 2. In addition, although nitrile rubber can be utilized for the friction material 5, silicone rubber is preferable from the viewpoint of thermal tolerance and abrasion resistance. In addition, nylon 66 may also be utilized. Furthermore, a friction paper commonly utilized as a friction material may also be utilized.

In the case of a blade tensioner 1 with this kind of configuration, when chord vibrations caused by thrashing of the chain and/or fluctuation of tension act upon the blade shoe 2, the respective blade springs 3 in the blade shoe 2 are subjected repeatedly to elastic deformation and return deformation as the blade shoe 2 deforms. As a result, adjoining blade springs 3 slide against each other and create a damping force. Furthermore, in such case, the friction material 5 provided at the tip part 21 of the blade shoe 2 slides on the sliding face 41 of the base 4 as the blade shoe 2 deforms, and great sliding resistance is created. The damping force of the blade tensioner 1 is further improved by such sliding resistance.

As described above, the blade tensioner 1 pertaining to an aspect of the invention offers an effect that because a friction material 5 is provided at the tip part 21 of the blade shoe 2, the damping force of the blade tensioner 1 can be improved due to the sliding resistance created as the friction material 5 slides on a sliding face 41.

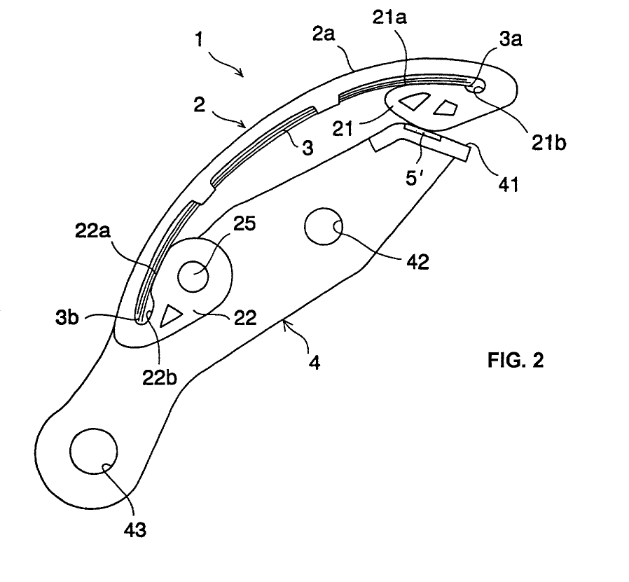

FIG. 2 shows a blade tensioner 1 in accordance with another aspect of the present invention. In FIG. 2, the same symbols as those in FIG. 1 indicate the same parts or the equivalent. This aspect of the invention is different from the aforementioned aspect of the invention in that a friction material 5′ is provided on the sliding face 41 of the base 41.

When chord vibrations caused by thrashing of the chain and/or fluctuation of tension act upon the blade shoe 2, not only is a damping force created by the resistance created as the adjoining blade springs 3 slide against each other, but the tip part 21 of the blade shoe 2 also slides against the friction material 5′ on the sliding face 41 as the blade shoe is deformed, and great sliding resistance is created. The damping force of the blade tensioner 1 is further improved by such sliding resistance.

The blade tensioner 1 pertaining to an aspect of the invention offers an effect that because friction material 5′ is provided on the sliding face 41 of the base 4, the damping force of the blade tensioner 1 can be improved due to the sliding resistance created as the tip part 21 of the blade shoe 2 slides against the friction material 5′.

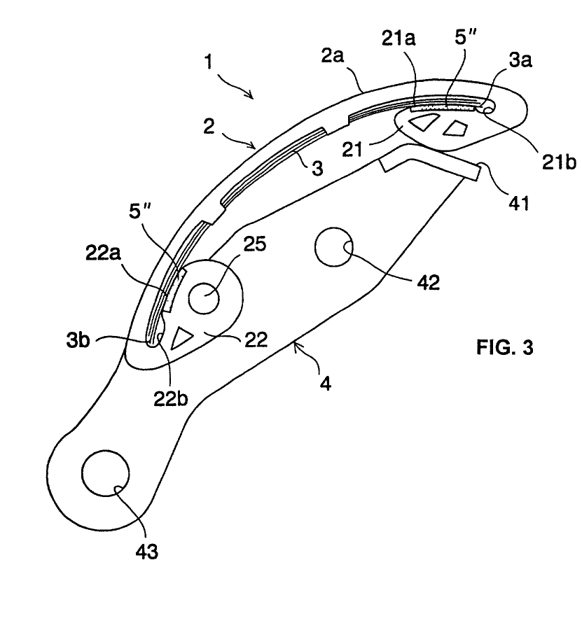

FIG. 3 shows a blade tensioner 1 in accordance with yet another aspect of the present invention. In FIG. 3, the same symbols as those in FIGS. 1 and 2 indicate the same parts or the equivalent. This aspect of the invention is different from the aforementioned aspects in that friction materials 5″ are provided at the base parts of respective slots 21a and 22a of the blade shoe 2 where they contact the blade springs 3.

When chord vibrations caused by thrashing of the chain and/or fluctuation of tension act upon the blade shoe 2, not only is a damping force created by the resistance as adjoining blade springs 3 slide against each other, but the blade spring 3 of the bottommost layer also slides against the friction materials 5″ provided at the base parts of the slots 21a and 22a, and great sliding resistance is created. The damping force of the blade tensioner 1 is further improved by such sliding resistance.

The blade tensioner 1 pertaining an aspect of the invention offers an effect that because friction materials are provided at the base parts of the respective slots 21a and 22a created at the tip part 21 and the base parts 22 of the blade shoe 2, the damping force of the blade tensioner 1 can be improved due to the sliding resistance created as the respective edge parts 3a and 3b of the blade springs slide against the friction materials 5″.

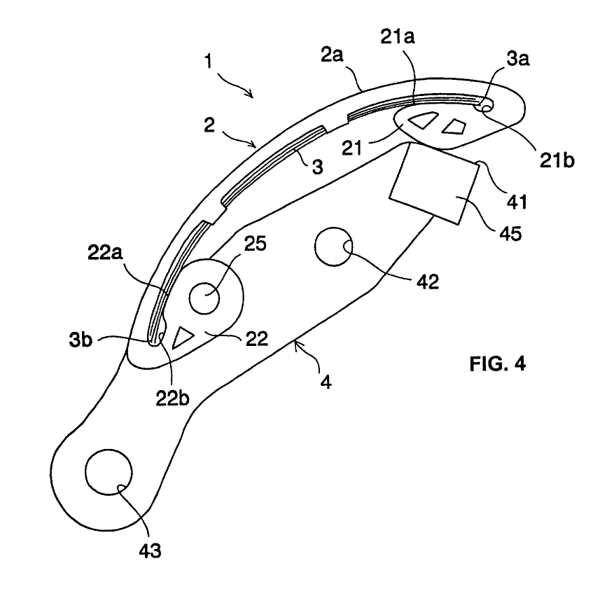

FIG. 4 shows a blade tensioner 1 in accordance with an aspect of the present invention. In FIG. 4, the same symbols as those in FIGS. 1 through 3 indicate the same parts or the equivalent. This aspect of the invention is different from the aforementioned aspects in that the sliding face 41 which contacts the tip part 21 of the blade shoe 2 is created on a plastic sliding block 45. The sliding block 45 is fixed to the tip of the base 4 using screws. It is desirable to use nylon 66 as a plastic material to create the sliding block 45.

When chord vibrations caused by thrashing of the chain and/or fluctuation of tension act upon blade shoe 2, not only is a damping force created by the resistance created as adjoining blade springs 3 slide against each other, but the tip part 21 of the blade shoe 2 also slides on the sliding face 41 of the sliding block 45, and great sliding resistance is created. The damping force of the blade tensioner 1 is further improved by such sliding resistance.

The blade tensioner 1 pertaining to the above aspect of the invention offers an effect that because the plastic sliding block 45 is provided on the base 4, the damping force of the blade tensioner 1 can be improved due to the sliding resistance created as the tip part 21 of the blade shoe 2 slides against the sliding block 45.

Furthermore, although it is not illustrated, any of the aforementioned aspects of the invention may be combined as needed in order to realize a blade tensioner with further improved damping force.

1. A blade tensioner for applying tension to a chain, the blade tensioner comprising:
a base having a sliding face;
a blade shoe having a first face and an opposing second face, the first face having a chain sliding face against which the chain is slidable, a first blade shoe portion pivotably supported by the base, and a second blade shoe portion freely slidable on the base sliding face;
a plurality of blade springs disposed on the second face of the blade shoe for applying a biasing force to the blade shoe; and
a friction surface disposed between the second blade shoe portion and the sliding face of the base providing a coefficient of friction therebetween effective to damp vibrations of the tensioner.

2. A blade tensioner according to claim 1, wherein the friction surface is attached to the second portion of the blade shoe by means of bonding, welding, or coating.

3. A blade tensioner according to claim 1, wherein the friction surface is inserted into the second portion of the blade shoe.

4. A blade tensioner according to claim 2, wherein the friction surface is configured using rubber, plastic, or friction paper.

5. A blade tensioner according to claim 1, wherein the friction surface is attached to the sliding face of the base by means of bonding, welding, or coating.

6. A blade tensioner according to claim 5, wherein the friction surface is configured using rubber, plastic, or friction paper.

7. A blade tensioner according to claim 1, wherein the sliding face comprises a sliding block attached to the base.

8. A blade tensioner according to claim 7, wherein the friction surface is disposed on the sliding block.

9. A blade tensioner for applying tension to a chain, the blade tensioner comprising:
a base having a sliding face;
a blade shoe having a first face and an opposing second face, the first face having a chain sliding surface against which the chain is slidable, the blade shoe having a first portion pivotably mounted to the base and a second portion freely slidable against the base sliding face, the second portion and the first portion having slots;
a plurality of blade springs disposed on the second face of the blade shoe, the blade springs having respective edge parts insertable into the slots of the first portion and the second portion of the blade shoe in order to apply a biasing force to the blade shoe; and
a friction surface provided between at least one of the slots of the blade shoe and at least one of the blade springs to provide sliding resistance therebetween effective to damp vibrations of the tensioner.

10. A blade tensioner according to claim 9, wherein the friction surface is attached to the slot by means of bonding, welding, or coating.

11. A blade tensioner according to claim 9, wherein the friction surface is inserted into the slot of the blade shoe.

12. A blade tensioner according to claim 11, wherein the friction surface is configured using rubber, plastic, or friction paper.

13. A method of applying tension to a chain with a blade tensioner, the method comprising:
providing a base having a sliding surface formed thereon;
pivotably attaching a first portion of a blade shoe to the base, the blade shoe having a chain sliding face and an opposing face opposite the chain sliding face, the blade shoe having a second portion slidable upon the base sliding surface;
biasing the blade shoe against the chain with at least one blade spring disposed on the opposing face of the blade shoe;
damping vibrations of the tensioner with a friction surface provided between the second portion of the shoe and the base sliding surface providing a coefficient of friction therebetween.

14. The method of applying tension to a chain according to claim 13, including mounting the friction surface to the base sliding surface.

15. The method of applying tension to a chain according to claim 13, including mounting the friction surface to the second portion of the shoe.

16. A method of applying tension to a chain with a blade tensioner, the method comprising:
providing a base having a sliding surface formed thereon;
pivotably attaching a first portion of a blade shoe to the base, the blade shoe having a second portion slidable upon the base sliding surface, the blade shoe having a chain sliding face and an opposing face opposite the chain sliding face having slots at the first and second portions;
biasing the blade shoe against the chain with at least one blade spring disposed on the opposing face of the blade shoe in the slots; and
damping vibrations of the tensioner with a friction surface provided between blade spring and the slot providing a coefficient of friction therebetween.

17. A method of applying tension to a chain according to claim 16, including mounting the friction surface to ends of the blade spring where the blade spring contacts the slots.

18. A method of applying tension to a chain according to claim 16, including mounting the friction surface to the slots of the shoe where the blade spring contacts the slots.
